(19) United States
(12) Patent Application Publication
(10) Pub. No.: US 2026/0276595 A1
(43) Pub. Date: Sep. 17, 2026

(54) SYSTEMS AND METHODS FOR DETERMINING THE ULTRASONIC TESTING (UT) TESTABILITY OF DEFECTS IN A WELD

(71) Applicant: Baker Hughes Holdings LLC, Houston, TX (US)

(72) Inventors: Thomas WUERSCHIG, Köln (DE); Joerg ININGER, Köln (DE)

(21) Appl. No.: 19/480,283

(22) PCT Filed: Apr. 29, 2024
(86) PCT No.: PCT/US2024/026763

§ 371 Date: Oct. 30, 2025

Related U.S. Application Data
(60) Provisional application No. 63/463,965, filed on May 4, 2023.

(51) Int. Cl. G01N 29/04; G01N 29/26; G01N 29/34

(52) U.S. Cl. CPC G01N 29/04; G01N 29/262; G01N 29/348; G01N 2291/023; G01N 2291/0289; G01N 2291/106; G01N 2291/267

(57) ABSTRACT

A system for determining the ultrasonic testability of an ultrasonic testing system is provided. The system can include a test object having a base material and a welded region, an ultrasonic probe comprising one or more ultrasonic transducers configured to acquire a plurality of measurements of the base material and the welded region and a computing system coupled to the ultrasonic probe and comprising at least one data processor and a memory storing instructions which, when executed by the at least one processor, cause the at least one processor to perform operations comprising: receiving, from the ultrasonic probe, the plurality of measurements of the base material and the welded region, determining a signal to noise ratio in the welded region based on the plurality of measurements, determining a degree of ultrasonic testability of the test object based on the signal to noise ratio and providing the degree of ultrasonic testability.

### RELATED APPLICATION

This application claims priority to U.S. Provisional Application No. 63/463,965 filed May 4, 2023, the entire contents of which are hereby expressly incorporated by reference herein.

### BACKGROUND

The present invention relates to the field of ultrasonic testing (UT). Specifically, the present invention relates to systems and methods for determining the UT testability of welded components.

### SUMMARY

In one aspect, a system for determining the ultrasonic testability of an ultrasonic testing system is provided. In some aspects, the system can include a test object including a base material and a welded region, an ultrasonic probe including one or more ultrasonic transducers arranged to acquire a plurality of measurements of the base material and the welded region and a computing system coupled to the ultrasonic probe and including at least one data processor and a memory storing instructions which, when executed by the at least one processor, cause the at least one processor to perform operations. In some aspects, the operations performed by the processor can include receiving, from the ultrasonic probe, the plurality of measurements of the base material and the welded region, determining a signal to noise ratio in the welded region based on the plurality of measurements, determining a degree of ultrasonic testability of the test object based on the signal to noise ratio and providing the degree of ultrasonic testability.

In some aspects, the at least one processor can be arranged to perform operations further including generating one or more ultrasonic scans of the test object based on the plurality of measurements, wherein the one or more ultrasonic scans include a maximum signal height, adjusting a gain of the computing system such that the maximum signal height is less than a full-scale height of the computing system and determining the degree of ultrasonic testability of the test object based on a gain difference between the base material and the welded region.

In some aspects, the test object can include a first defect having predetermined characteristics in the base material and a second defect having predetermined characteristics in the welded region. In this case, the at least one processor can be arranged to perform operations further including receiving, from the ultrasonic probe, a first plurality of measurements of the first defect, receiving, from the ultrasonic probe, a second plurality of measurements of the second defect and receiving, from the ultrasonic probe, a third plurality of measurements of a flaw-free area of the test object. In some aspects, the flaw-free area can be in the welded region.

In some aspects, the first defect can be a first hole having a first diameter and the second defect can be a second hole having a second diameter, wherein the first and second diameters are sized based on application specific specifications.

In some aspects, the first plurality of measurements can be taken from a first plurality of positions on a first face of the test object, the second plurality of measurements can be taken from a second plurality of positions on the first face, and the third plurality of measurements can be taken from a third plurality of positions on the first face.

In some aspects, the ultrasonic probe can be a phased array, and the at least one processor can be further arranged to perform operations including receiving, from the ultrasonic probe, the first plurality of measurements, the second plurality of measurements and the third plurality of measurements at a plurality of measurements at each of the plurality of positions across a predetermined range of angles of incidence, determining one or more optimal angles of incidence and determining the degree of ultrasonic testability of the test object based on the plurality of measurements taken at the one or more optimal angles of incidence.

In some aspects, the ultrasonic probe can be a phased array, and the at least one processor can be further arranged to perform operations including receiving, from the ultrasonic probe, the plurality of measurements at each of the plurality of positions across a predetermined range of ultrasonic beam frequencies, determining one or more optimal ultrasonic beam frequencies and determining the degree of ultrasonic testability of the test object based on the plurality of measurements taken at the one or more optimal ultrasonic beam frequencies.

In some aspects, the ultrasonic probe can be a phased array, and the at least one processor can be further configured to perform operations including receiving, from the ultrasonic probe, the plurality of measurements at each of the plurality of positions across a predetermined range of focal point distances, determining one or more optimal focal point distances and determining the degree of ultrasonic testability of the test object based on the plurality of measurements taken at the one or more optimal focal point distances.

In another aspect, a method of non-destructive testing is provided. In some aspects, the method can include acquiring, by an ultrasonic probe communicatively coupled a computing system including at least one data processor and a memory storing instructions, a plurality of measurements of a test object including a base material and a welded region, receiving, by the at least one processor, from the ultrasonic probe, the plurality of measurements of the base material and the welded region, determining, by the at least one processor, a signal to noise ratio in the welded region based on the plurality of measurements, determining, by the at least one processor, a degree of ultrasonic testability of the test object based on the signal to noise ratio and providing the degree of ultrasonic testability.

In some aspects, the method can further include generating, by the at least one processor, one or more ultrasonic scans of the test object based on the plurality of measurements, wherein the one or more ultrasonic scans include a maximum signal height, adjusting, by the at least one processor, a gain of the computing system such that the maximum signal height is less than a full-scale height of the computing system and determining, by the at least one processor, the degree of ultrasonic testability of the test object based on a gain difference between the base material and the welded region.

In some aspects, the test object can include a first defect having predetermined characteristics in the base material and a second defect having predetermined characteristics in the welded region. In this case, the method can further include receiving, by the at least one processor, a first plurality of measurements of the first defect, receiving, by the at least one processor, a second plurality of measurements of the second defect and receiving, from the ultrasonic probe, a third plurality of measurements of a flaw-free area of the test object. In some aspects, the flaw-free area can be in the welded region.

In some aspects, the first defect can be a first hole having a first diameter and the second defect can be a second hole having a second diameter, wherein the first and second diameters are sized based on application specific specifications.

In some aspects, the first plurality of measurements can be taken from a first plurality of positions on a first face of the test object, the second plurality of measurements can be taken from a second plurality of positions on the first face, and the third plurality of measurements can be taken from a third plurality of positions on the first face.

In some aspects, the ultrasonic probe can be a phased array and the method can further include receiving, by the at least one processor, the plurality of measurements at each of the plurality of positions across a predetermined range of angles of incidence, determining, by the at least one processor, one or more optimal angles of incidence and determining, by the at least one processor, the degree of ultrasonic testability of the test object based on the plurality of measurements taken at the one or more optimal angles of incidence.

In some aspects, the ultrasonic probe can be a phased array and the method can further include receiving, by the at least one processor, the plurality of measurements at each of the plurality of positions across a predetermined range of ultrasonic beam frequencies, determining, by the at least one processor, one or more optimal ultrasonic beam frequencies and determining, by the at least one processor, the degree of ultrasonic testability of the test object based on the plurality of measurements taken at the one or more optimal ultrasonic beam frequencies.

In some aspects, the ultrasonic probe can be a phased array and the method can further include receiving, by the at least one processor, the plurality of measurements at each of the plurality of positions across a predetermined range of focal point distances, determining, by the at least one processor, one or more optimal focal point distances and determining, by the at least one processor, the degree of ultrasonic testability of the test object based on the plurality of measurements taken at the one or more optimal focal point distances.

### DESCRIPTION OF DRAWINGS

These and other features will be more readily understood from the following detailed description taken in conjunction with the accompanying drawings, in which:

FIG. 1 illustrates one exemplary embodiment of an operating environment containing an ultrasonic testing system and an object;

FIG. 2 is a diagram illustrating an exemplary test object that can be used to determine UT testability of an object;

FIG. 3 is a diagram illustrating an exemplary configuration for obtaining measurements of a first surface and a second surface of a test object with a probe only being positioned on the first surface;

FIG. 4A is a graph that illustrates an exemplary ultrasonic scan that can be generated by a computing system based on a plurality of measurements taken of a reference flaw of the test object of FIG. 2;

FIG. 4B is a graph that illustrates an exemplary ultrasonic scan that can be generated by a computing system based on a plurality of measurements taken of a flaw-free region of the test object of FIG. 2;

FIG. 5 is a schematic diagram illustrating an alternative embodiment of the ultrasonic probe and the ultrasonic controller of FIG. 1 in greater detail; and

FIG. 6 is a diagram illustrating a method for determining the ultrasonic testability of a test object as described herein.

It is noted that the drawings are not necessarily to scale. The drawings are intended to depict only typical aspects of the subject matter disclosed herein, and therefore should not be considered as limiting the scope of the disclosure.

### DETAILED DESCRIPTION

UT testability refers to the ability of a material or component to be inspected using ultrasonic waves. UT testability is a critical metric to consider when performing ultrasonic inspections of welds. The UT testability of welded components can depend on a variety of factors including the base material of the component, the mechanical properties (geometry, bead uniformity) of the weld, the size and shape of the component, and the thickness of the component, to name a few. UT testability can be determined, in part by determining a signal-to-noise ratio (SNR) of an ultrasonic signal that represents a flaw that is present in a material to an ultrasonic signal that represents general background noise in a material. The greater the SNR for a material, the better the UT testability, as the noise is small relative to the flaw signal.

Sound propagation in a welded region of a component, including such effects like an anisotropic attenuation in different spatial directions, make the necessity of systems and methods for accurate UT testability even more critical. While some definitions on the SNR are given in common standards, a precise system and method for obtaining accurate SNR values is lacking. For example, in some cases, a material being tested may be anisotropic, meaning that the material's physical properties such as mechanical, thermal, or electrical properties, are directionally dependent. Current systems and methods for determining the SNR for materials do not sufficiently account for anisotropic properties of materials which can affect the accuracy of measurements and the interpretation of results. In practice, the uncertainty of inaccurate SNR values can lead to time and cost intensive delays due to potential disagreements on testability, re-manufacturing of components for commissioning, and audits. In the worst case, this uncertainty can lead to a redesign of an overall testing setup (e.g. by adaptation of the test frequency).

The systems and methods described herein can address the aforementioned shortcomings. For example, one or more embodiments of the systems and methods herein can provide a standardized procedure for extracting the UT testability of welded objects. The systems and methods described herein combine a plurality of UT measurements of a plurality of regions of interest (ROI) of an object, with each measurement taken from a direction relative to the ROIs to ensure that any anisotropic properties of the object material are properly accounted for. The systems and methods described herein can use a test object having predefined ROIs (e.g., areas having predefined reference defects) within a base material of the object as well as within a welded region of the object. By acquiring a plurality of UT measurements of the test object at a plurality of angles and ROIs, and comparing the measurements, it is possible to obtain a quantitative criterion for the UT testability of the welded object. For example, in some embodiments, the system and method described herein can be configured to take measurements of a drilled hole inside of a base material, as well as inside of a weld volume from a plurality of different angles surrounding the drilled holes, and compare the measurements to determine a UT testability of the object/material, as discussed in greater detail below.

In some cases, the systems and methods described herein can provide a user with a determination as to whether or not a given object can effectively be tested using UT techniques based on a given specification. For example, in some cases, a determination that an object cannot be effectively be tested using UT techniques can be a result of the object material's composition, thickness, or geometry that make it difficult for ultrasonic waves to penetrate or propagate through the material, or may produce high levels of noise or interference that make it difficult to accurately detect and measure defects.

The current subject matter can advantageously provide a standardized and reproducible SNR measurement for welded objects, allowing a classification with respect to the UT testability.

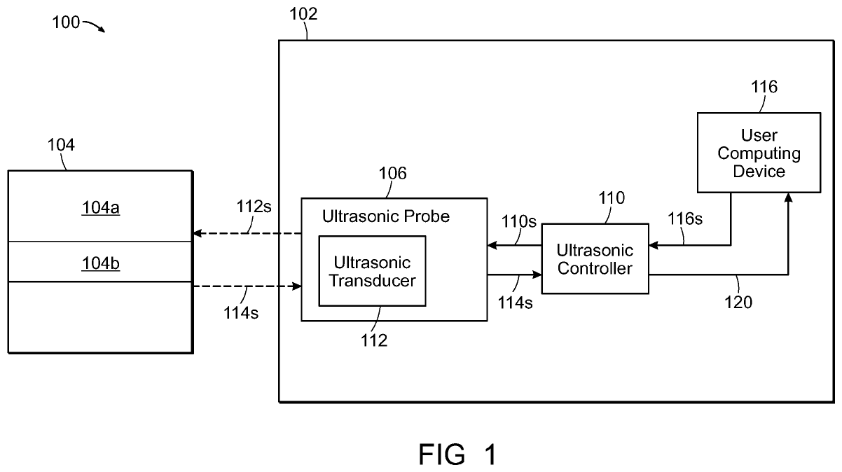

FIG. 1 illustrates one exemplary embodiment of an operating environment 100 containing an ultrasonic testing system 102 and an object 104. The ultrasonic testing system 102 can include an ultrasonic probe 106, an ultrasonic controller 110, and a user computing device 116. The ultrasonic controller 110 is in signal communication with the ultrasonic probe 106 and the user computing device 116.

The ultrasonic probe 106 can include one or more ultrasonic transducers 112. In some embodiments, the ultrasonic probe 106 can include a housing. The one or ultrasonic transducers 112 can each be configured to generate respective ultrasonic waves in response to one or more driving signals 110s provided to the ultrasonic probe 106 by the ultrasonic controller 110. The combination of respective ultrasonic waves can be a waveform having predetermined characteristics, referred to herein as an incident ultrasonic signal 112s or incident signal 112s. The ultrasonic transducers 112 can also be configured to detect ultrasonic waves reflected back to the ultrasonic sensor 106 from the object 104, referred to herein as return ultrasonic signals 114s or return signals 114s.

In use, the ultrasonic probe 106 can be positioned proximate to the object 104 (e.g., in contact with or near the object 104) for measuring the return ultrasonic signals 114s. As discussed in greater detail below, a user can employ the user computing device 116 to specify the predetermined characteristics of incident signals 112s (e.g., amplitude, frequency, duration, shape, angle of incidence, etc.) to be generated by the ultrasonic transducers 112, as discussed in greater detail below. These characteristics can be provided to the ultrasonic controller 110 in the form of command signals 116s to the ultrasonic controller 110. In response to receipt of the command signals 116s, the ultrasonic controller 110 can generate corresponding driving signals 110s operative to cause the ultrasonic transducers 112 to generate the incident signals 112s with the selected characteristics. The ultrasonic transducers 112 can further receive the return ultrasonic signals 114s. The return ultrasonic signals 114s can be output to the ultrasonic controller 110. The ultrasonic controller 110 can further output the ultrasonic scans 120 for storage and/or display by the user computing device 116 for analysis to, to aid in the determination of the UT testability of the object 104.

So configured, the ultrasonic testing system 102 provides a variety of benefits. In one aspect, the characteristics of the incident signals 112s can be selected based upon the acoustic properties of the object 104, facilitating penetration of the incident signals 112s into the object 104 by a predetermined amount. For example, in some cases, the object 104 can be a welded component and can include one or more weld-free regions 104a and one or more welded regions 104b, each of which can display unique acoustic properties, as will be discussed in greater detail below. In one aspect, the characteristics of the ultrasonic waveforms can be selected for short distance penetration, providing ultrasonic scans relatively close to the surface of the object 104. In another aspect, the characteristics of the ultrasonic waveforms can be selected for long distance penetration, providing ultrasonic scans within the bulk of the object 104. In either case, relatively high resolution images of a desired region of the object 104 can be obtained. In another aspect, the ability of the ultrasonic testing system 102 to tailor the incident signals 112s to the acoustic properties of the object 104 allows the single ultrasonic probe 106 to replace multiple ultrasonic probes of different types. In this manner, ultrasonic testing can be performed with reduced cost and complexity.

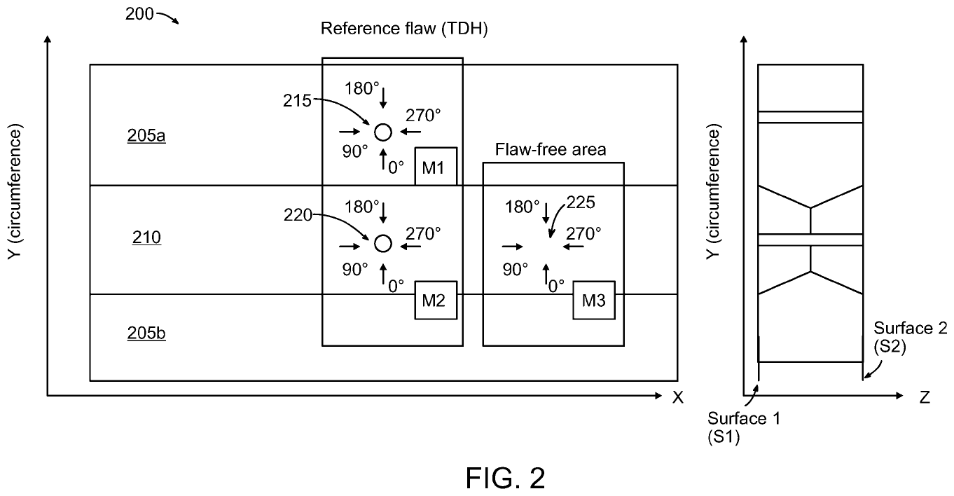

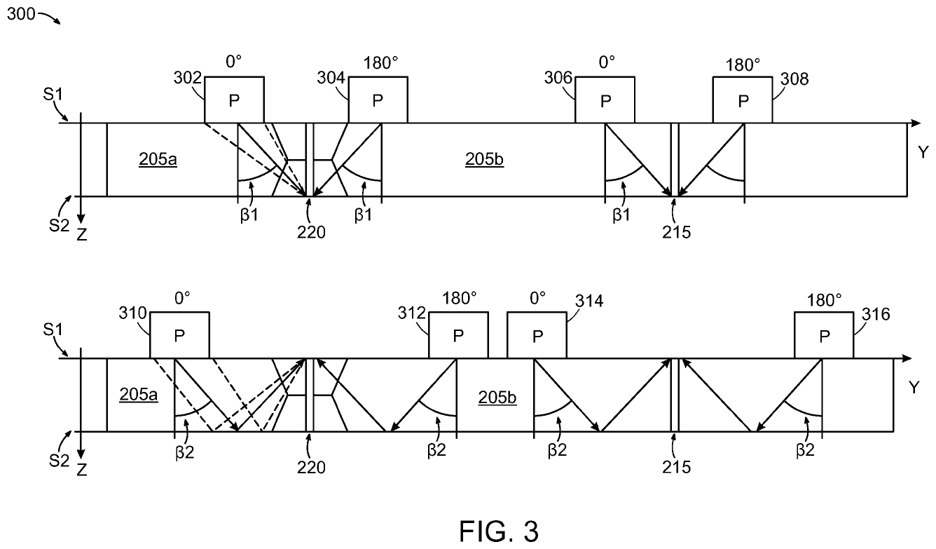

FIG. 2 is a diagram illustrating an exemplary test object 200 that can be used to determine UT testability of an object. In some embodiments, the test object 200 can be used, for example, in the operating environment 100 in place of object 104. Specifically, the test object 200 can be used to determine UT testability defects in a weld of an object. In some embodiments, the test object can include portions 205a and 205b of a base material 205 and a welded region 210. The test object 200 can further include a first defect 215 having predetermined characteristics. For example, in some aspects, the first defect can be a first hole 215, having known dimensions, drilled into the base material 205. The test object 200 can further include a second defect 220 having predetermined characteristics. For example, in some aspects, the second defect can be a second hole 220, having known dimensions, drilled into the welded region 210. The first and second holes 215, 220 can have a first and second diameters, respectively. In some embodiments, the first and second diameters can be sized based on application specific specifications. In some embodiments, the test object 200 can be a flat plate having a first surface S1 and a second surface S2. In some embodiments, the test object 200 can be a curved plate or a pipe having a first surface S1 (e.g., an outer surface) and a second surface S2 (e.g., and inner surface). In some cases, the test object 200 can be a phantom that is made from the same materials as a real object of interest, but includes predefined defects (holes 215 and 220) to allow for accurate ultrasonic testability determination. For example, in some embodiments, the first and second diameters can be sized according to specifications laid out in American Society for Testing and Materials (ASTM) E164 (Standard Practice for Ultrasonic Contact Examination of Weldments). However, other specifications can be used (e.g., other ASTM specifications, European Norm (EN) specifications, and/or American Petroleum Institute (API) specifications). An exemplary scanning operation for determining the ultrasonic testability of an ultrasonic testing system, using the ultrasonic testing system 102, computing device 116 and test object 200 is provided below with reference made to FIG. 2 and FIG. 3.

In some embodiments, to determine the testability of a welded object, it can be valuable to take a plurality of measurements of a region of interest (e.g., the predetermined defects) to properly account for any anisotropy in the material being tested. Accordingly, in some embodiments, the UT system 102 can be configured to take a plurality of measurements of the regions of interest of the base material and the welded region. For example, as illustrated in FIG. 2 the system can be configured to take measurements of the first hole 215 in the base material 205 from four different positions surrounding the circumference of the hole 215 to ensure that any anisotropy is accounted for. Similarly, the system can be configured to take measurements of the second hole 220 and measurements of the flaw-free area 225 in the welded region 210 from four different positions surrounding the circumference of the hole 220 and the flaw-free area 225, respectively.

To determine the ultrasonic testability of an object having two surfaces, it can be necessary to obtain measurement at both surfaces of the object. However, in many cases, an interior surface (e.g., S2 of FIG. 2) can be inaccessible by a probe. For example, in a case where the object being tested is a pipe, the interior surface of the pipe may be inaccessible by a probe (e.g., probe 106 of FIG. 1).

Accordingly, FIG. 3 is a diagram illustrating a configuration 300 for obtaining measurements of a first surface S1 and a second surface S2 of a test object (e.g., test object 200) with a probe P only being positioned on the first surface S1. In some embodiments, the probe P can be similar to probe 106 of FIG. 1. For example, the probe P can be positioned at a first plurality of positions (e.g., 306, 308) on the first surface S1 and configured to acquire measurements of the second surface S2 by transmitting ultrasonic signals at a first frequency and a first angle of incidence β1 toward the first hole 215. In the measurements taken of the second surface S2, the signal strength of the measurements are correlated to reflector/defect size. Similar measurements can be made for the second hole 220 and the flaw-free area (not shown).

To acquire measurements of the first surface S1, the probe P can be positioned around the first hole, the second hole, and the flaw-free area such that the ultrasonic signals that are transmitted at the first frequency and a second angle of incidence β2 are reflected off of the second surface S2 and directed toward the first hole, the second hole, and the flaw-free area, respectively, at the first surface S1. The signals that are reflected off of the second surface S2 and directed toward the first hole, the second hole, and the flaw-free area, respectively can be recorded as reflexions from the inverse sound path. Similarly to the measurements taken of the second surface S2, the signal strength of the measurements taken of the first surface S1 are correlated to reflector/defect size.

For example, the probe P can be positioned at a second plurality of positions (e.g., 314, 316) on the first surface S1 and can be configured to acquire measurements of the first surface S1 by transmitting ultrasonic signals at a first frequency and a second angle of incidence β2. The second angle of incidence β2 can be chosen such that the ultrasonic signals transmitted are reflected off of the second surface S2 and directed toward the first hole 215. Similar measurements can be made for the second hole 220 and the flaw-free area (not shown).

As illustrated in FIG. 3, in some embodiments, the position of the probe P when acquiring measurements of the first surface S1 and/or the second surface S2 can be outside of the welded region 210 (in reference to FIG. 2) depending on the geometry of the welded region 210. Further, in some embodiments, a heating area can exist in between the welded region 210 and the base material 205a/205b where the base material 205a/205b is affected by the heat that is generated during the welding process. In this case, the position of the probe P when acquiring measurements of the first surface S1 and/or the second surface S2 can be outside of the heating area to optimize the SNR.

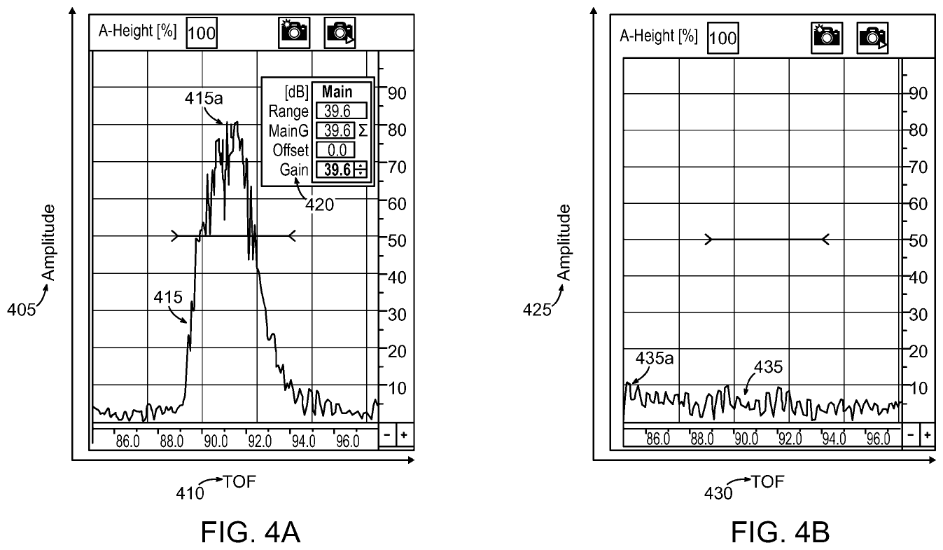

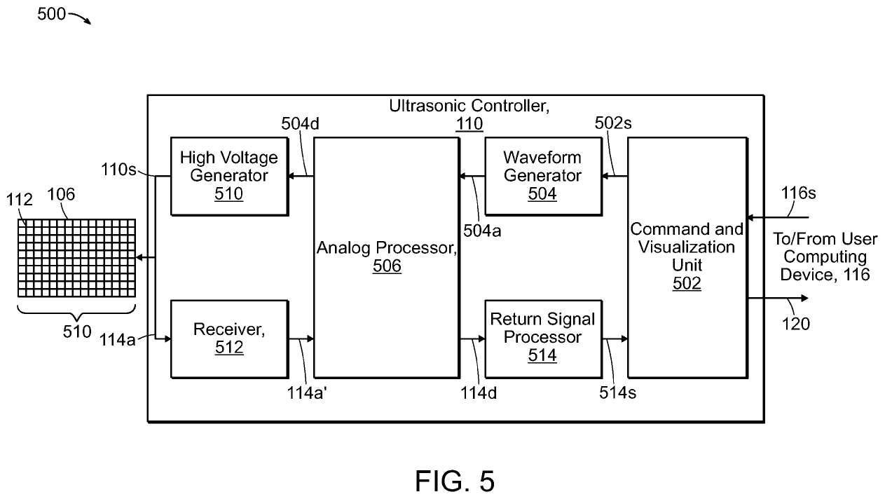

FIG. 4A is a graph that illustrates an exemplary ultrasonic scan that can be generated by a computing system (e.g., computing device 116) based on the plurality of measurements taken of the test object 200 at the second hole 220 of FIG. 2. In some embodiments, the ultrasonic scan can be generated similarly to the A-scans 514s of FIG. 5, as discussed in greater detail below.

The ultrasonic scan can include an amplitude axis 405 and a time of flight (TOF) axis 410. The data from the plurality of measurements can be plotted in the scan of FIG. 4A as a signal 415, which can include a maximum signal height 415a. In some embodiments, the computing system (e.g., computing device 116) can be configured to adjust a gain 420 of the computing system such that the maximum signal height 415a of the plurality of measurements is less than a full scale height of the computing system. For example, in some embodiments, the gain 420 can be adjusted such that the maximum signal height 410 of the plurality of measurements is 80% of the full scale height of the computing system, as illustrated in FIG. 4A.

FIG. 4B is a graph that illustrates an exemplary ultrasonic scan that can be generated by a computing system (e.g., computing device 116) based on the plurality of measurements taken of the test object 200 at the flaw-free area 225 of FIG. 2. In some embodiments, the ultrasonic scan can be generated similarly to the A-scans 514s of FIG. 5, as discussed in greater detail below.

The ultrasonic scan can include an amplitude axis 425 and a time of flight (TOF) axis 430. The data from the plurality of measurements can be plotted in the scan of FIG. 4B as a signal 435, which can include a maximum signal height 435a. In some embodiments, the SNR of the welded region 210 of FIG. 2 can be determined by dividing the maximum signal height 415a of FIG. 4A by the maximum signal height 435a of FIG. 4B.

FIG. 5 is a schematic diagram 500 illustrating an alternative embodiment of the ultrasonic probe 106 and the ultrasonic controller 110 in greater detail. In this embodiment, the ultrasonic probe 106 includes an array 510 (e.g., a rectangular array) of individual ultrasonic transducers 112. In an embodiment, each ultrasonic transceiver 112 is a piezoelectric transceiver element. In alternative embodiments, other types of ultrasonic transceivers can be employed, such as electromagnetic acoustic transducers (EMATs) or capacitive micro-machined ultrasonic transducers (CMUTs) to enable the ultrasonic testing system 102 to function as described.

Each ultrasonic transducer 112 can be configured to transmit the incident signals 112s and to receive the return ultrasonic signals 114s. As an example, the ultrasonic transducer 112 can be configured to generate ultrasonic waves resulting in incident signals 112s having different one or more frequencies within the range from about 1 MHz to about 15 MHz. The shape of the incident signals 112s predetermined shapes, also referred to herein as chirps. The incident signals 112s can further exhibit precise modulation with high bandwidth.

As further shown in FIG. 5, the ultrasonic controller 110 includes a command and visualization unit 502, a waveform generator 504, an analog processor 506, a high voltage generator 510, a receiver 512, and a return signal processor 514. The command signals 116s specifying the characteristics the incident signals 112s can be output by the user computing device 116 and be received by the command and visualization unit 502. The command and visualization unit 502 can convert the command signals 116s into instructions 502s for receipt by the waveform generator 504. In response to receipt of the instructions 502s, the waveform generator 504 can generate corresponding analog excitation signals 504a for each of the ultrasonic transducers 112. The analog processor 506 can convert the digital excitation signals 504d into analog excitation signals 506a for receipt by the high voltage generator 510. The high voltage generator 510 can include one or more amplifiers that are configured to amplify the analog excitation signals 506a to generate the driving signals 110s for receipt by the ultrasonic transducers 112.

The return signals 114s received by the ultrasonic probe 106 can be converted into analog return signals 114a by respective ones of the ultrasonic transducers 112. That is, at least a portion of the ultrasonic transducers 112 can output a respective analog return signal 114a and these analog return signals 114s can be directed to the receiver 512. The receiver 512 can include one or more amplifiers configured to amplify the analog return signals 114a and output corresponding amplified analog return signals 114a′. The analog processor 506 can convert the amplified analog return signals 114a′ into digital return signals 114d for receipt by the return signal processor 514.

The return signal processor 514 can be configured use the digital return signals 114d in a summation process (e.g., a numerical construction) to generate ultrasonic scans (e.g., A-scans 514s) of the object 104. In an embodiment, the return signal processor 514 can include field-programmable gate arrays (FPGAs) to perform this summation. In alternative embodiments, the return signal processor can include application-specific integrated circuits (ASICs) for performing this summation.

The generated A-scans 514s can be output to the command and visualization unit 502 for further processing. In general, the A-scans 514s form a raw virtual image of the object 104. In some aspects, the command and visualization unit 502 can be configured to process the A-scans 514s to remove noise by optimizing echoes created by features within the object 104 that might serve as reflectors of the ultrasonic signals 512s. These reflectors can represent flaws within the object 104.

In some aspects, the command and visualization unit 502 can be configured to perform ultrasonic test evaluations on the A-scans 514s. Each A-scan 514s represents a plurality of reflections of the incident signals 112s taken at predetermined time intervals and positions about the object 104. Accordingly, the A-scans 514s can be employed to generate a three-dimensional ultrasonic “field” of the object 104. After processing the A-scans 514s, ultrasonic scans 120 can be output from the command and visualization unit 502 to the user computing device 116 for storage and/or display. For example, In some embodiments, the visualization unit 502 can be further configured to compile a plurality of A-scan data 514s into one or more C-scans which can be used for more advanced/complex evaluation.

In some aspects, the command and visualization unit 502 can correlate data acquired during ultrasonic testing with positions on the object 104. As an example, the ultrasonic testing system 102 can include a plurality of position encoders (not shown) coupled to the array 510 and in electrical communication with the command and visualization unit 502. The position encoders can record and output the position of the array 510 relative to the object 104. Analysis of the ultrasonic field by the command and visualization unit 502 can include selection of a segment or “slice” in time (also referred to as a “gate”). The gate can be analyzed to determine the largest sound wave amplitude within the gate, and a measured time in flight associated with that amplitude. “Time of flight” can refer to the amount of time required for a sound wave to travel through the object. The selected amplitude can be compared to predetermined reference amplitude, and the measured time of flight can be compared to a predetermined reference time of flight. If the selected amplitude exceeds the value of the reference amplitude, then a defect is deemed to be present at a physical location within the object that is associated with the selected gate. For example, a measured time of flight associated with a selected gate that registers below the predefined reference time of flight, may be indicative that the strength of the material in the object 104, at the associated location may be too low, as may be associated with internal corrosion at that location. Alternatively, for situations in which corrosion is present on an external surface of object 104, the measured time of flight may be greater than the predetermined reference time of flight.

In some embodiments, an optimal angle of incidence within the material (e.g., angle β1 and/or angle β2) to be used for determining the ultrasonic testability of the object can be determined by the computing system. When a phased array (e.g., phased array 510) is used to acquire the plurality of measurements of the test object 200, the plurality of measurements taken at each of the plurality of positions can be taken across a predetermined range of angles of incidence. For example, in some embodiments, the plurality of measurements can be taken at each of the plurality of positions at a plurality of angles of incidence ranging from, for example, 45 degrees to 70 degrees. Based on the plurality of measurements that are taken at the plurality of angles of incidence, one or more optimal angles of incidence (e.g., angle β1 and/or angle β2) can be determined. In some embodiments, the one or more optimal angles of incidence can be determined based on which angle of incidence provides the largest SNR. For example, as discussed above in reference to FIGS. 4A-4B, a plurality of SNRs can be determined by dividing the maximum signal height 415a of FIG. 4A taken at a plurality of angles of incidence, by the maximum signal height 435a of FIG. 4B taken at the plurality of angles of incidence. The one or more optimal angles of incidence can be determined based on the largest SNR of the plurality of SNRs. In some embodiments, it may further be necessary for the largest SNR to be greater than 12 dB, meaning that the maximum signal height 415a of FIG. 4A must be greater than four times the maximum signal height 435a of FIG. 4B. However, in some embodiments, the necessary SNR may be greater than or less than 12 dB. In this embodiment, the degree of ultrasonic testability of the test object can be determined based on the plurality of measurements taken at the one or more optimal angles of incidence.

In some embodiments, an optimal beam frequency to be used for determining the ultrasonic testability of the object can be determined by the computing system. When a single transducer probe, or phased array (e.g., phased array 510) is used to acquire the plurality of measurements of the test object 200, the plurality of measurements taken at each of the plurality of positions can be taken across a predetermined range of beam frequencies. For example, in some embodiments, the plurality of measurements can be taken at each of the plurality of positions at a plurality of beam frequencies ranging from, for example, 1 MHz to about 15 MHZ, as discussed above. Based on the plurality of measurements that are taken at the plurality of beam frequencies, one or more optimal beam frequencies can be determined. In some embodiments, the one or more optimal beam frequencies can be determined based on which beam frequencies provide the clearest scan. In some embodiments, the one or more optimal beam frequencies can be determined based on which beam frequency provides the largest SNR, similarly to as discussed above. In this embodiment, the degree of ultrasonic testability of the test object can be determined based on the plurality of measurements taken at the one or more optimal beam frequencies.

In some embodiments, an optimal focal point distance to be used for determining the ultrasonic testability of the object can be determined by the computing system. When a phased array (e.g., phased array 510) is used to acquire the plurality of measurements of the test object 200, the plurality of measurements taken at each of the plurality of positions can be taken across a predetermined range of focal point distances. For example, in some embodiments, the plurality of measurements can be taken at each of the plurality of positions at a plurality of focal point distances ranging from, for example, 5 mm to 200 mm. Based on the plurality of measurements that are taken at the plurality of focal point distances, one or more optimal focal point distances can be determined. In some embodiments, the one or more optimal focal point distances can be determined based on which focal point distances provide the clearest scan. The optimal focal point distance can depend on how accurate the mechanical positioning of the probes can be. For example, in some cases, based on the geometry of the test object, it can be difficult to position the proximal to the region of interest. In this case, it may be desirable to have a focal point distance such that the region of interest is scanned more broadly. Alternatively, if the probe can be positioned more proximal to the region of interest, it may be desirable to have a focal point distance such that the region of interest is scanned in a more targeted fashion.

In some embodiments, the one or more optimal focal point distances can be determined based on which focal point distance provides the largest SNR, similarly to as discussed above. In this embodiment, the degree of ultrasonic testability of the test object can be determined based on the plurality of measurements taken at the one or more optimal focal point distances.

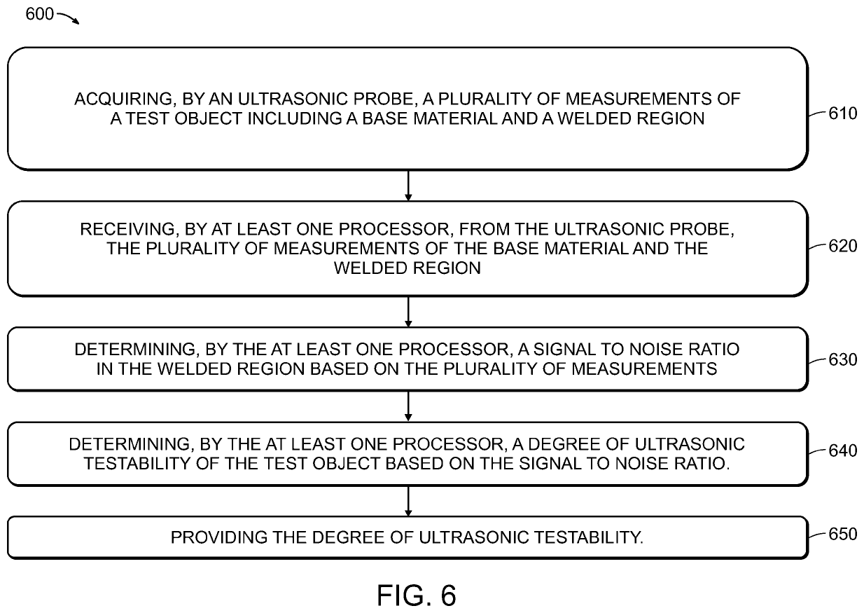

FIG. 6 is a diagram illustrating a method 600 for determining the ultrasonic testability of a test object as described herein. The method 600 can include a step 610 of acquiring, by an ultrasonic probe communicatively coupled a computing system including at least one data processor and a memory storing instructions, a plurality of measurements of a test object including a base material and a welded region. The method 600 can also include a step 620 of receiving, by at least one processor, from the ultrasonic probe, the plurality of measurements of the base material and the welded region. The method 600 can also include a step 630 of determining, by the at least one processor, a signal to noise ratio (SNR) in the welded region based on the plurality of measurements. In some aspects, the SNR can be determined from one or more ultrasonic scans of the test object generated by the processor. The method 600 can also include a step 640 of determining, by the at least one processor, a degree of ultrasonic testability of the test object based on the signal to noise ratio. The method 600 can also include a step 650 of providing the degree of ultrasonic testability.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and serially-arranged by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be serially-arranged by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A system, comprising:
a test object comprising a base material and a welded region;
an ultrasonic probe comprising one or more ultrasonic transducers configured to acquire a plurality of measurements of the base material and the welded region; and
a computing system coupled to the ultrasonic probe and comprising at least one data processor and a memory storing instructions which, when executed by the at least one processor, cause the at least one processor to perform operations comprising:
receiving, from the ultrasonic probe, the plurality of measurements of the base material and the welded region;
determining a signal to noise ratio in the welded region based on the plurality of measurements;
determining a degree of ultrasonic testability of the test object based on the signal to noise ratio; and
providing the degree of ultrasonic testability.

2. The system of claim 1, wherein the at least one processor is configured to perform operations further comprising:
generating one or more ultrasonic scans of the test object based on the plurality of measurements, wherein the one or more ultrasonic scans include a maximum signal height;
adjusting a gain of the computing system such that the maximum signal height is less than a full-scale height of the computing system; and
determining the degree of ultrasonic testability of the test object based on a gain difference between the base material and the welded region.

3. The system of claim 1, wherein the test object comprises a first defect having predetermined characteristics in the base material and a second defect having predetermined characteristics in the welded region, and the at least one processor is configured to perform operations further comprising:
receiving, from the ultrasonic probe, a first plurality of measurements of the first defect;
receiving, from the ultrasonic probe, a second plurality of measurements of the second defect; and
receiving, from the ultrasonic probe, a third plurality of measurements of a flaw-free area of the test object.

4. The system of claim 3, wherein the flaw-free area is in the welded region.

5. The system of claim 3, wherein the first defect is a first hole having a first diameter and the second defect is a second hole having a second diameter, wherein the first and second diameters are sized based on application specific specifications.

6. The system of claim 3, wherein the first plurality of measurements are taken from a first plurality of positions on a first face of the test object, the second plurality of measurements are taken from a second plurality of positions on the first face, and the third plurality of measurements are taken from a third plurality of positions on the first face.

7. The system of claim 6, wherein the ultrasonic probe is a phased array, and the at least one processor is further configured to perform operations including:
receiving, from the ultrasonic probe, the first plurality of measurements, the second plurality of measurements and the third plurality of measurements at a plurality of measurements at each of the plurality of positions across a predetermined range of angles of incidence;
determining one or more optimal angles of incidence; and
determining the degree of ultrasonic testability of the test object based on the plurality of measurements taken at the one or more optimal angles of incidence.

8. The system of claim 6, wherein the ultrasonic probe is a phased array, and the at least one processor is further configured to perform operations including:
receiving, from the ultrasonic probe, the plurality of measurements at each of the plurality of positions across a predetermined range of ultrasonic beam frequencies;
determining one or more optimal ultrasonic beam frequencies; and
determining the degree of ultrasonic testability of the test object based on the plurality of measurements taken at the one or more optimal ultrasonic beam frequencies.

9. The system of claim 6, wherein the ultrasonic probe is a phased array, and the at least one processor is further configured to perform operations including:
receiving, from the ultrasonic probe, the plurality of measurements at each of the plurality of positions across a predetermined range of focal point distances;
determining one or more optimal focal point distances; and
determining the degree of ultrasonic testability of the test object based on the plurality of measurements taken at the one or more optimal focal point distances.

10. A method of non-destructive testing, comprising:
acquiring, by an ultrasonic probe communicatively coupled a computing system including at least one data processor and a memory storing instructions, a plurality of measurements of a test object including a base material and a welded region;
receiving, by the at least one processor, from the ultrasonic probe, the plurality of measurements of the base material and the welded region;
determining, by the at least one processor, a signal to noise ratio in the welded region based on the plurality of measurements;
determining, by the at least one processor, a degree of ultrasonic testability of the test object based on the signal to noise ratio; and
providing the degree of ultrasonic testability.

11. The method of claim 10, further comprising:
generating, by the at least one processor, one or more ultrasonic scans of the test object based on the plurality of measurements, wherein the one or more ultrasonic scans include a maximum signal height;
adjusting, by the at least one processor, a gain of the computing system such that the maximum signal height is less than a full-scale height of the computing system; and
determining, by the at least one processor, the degree of ultrasonic testability of the test object based on a gain difference between the base material and the welded region.

12. The method of claim 10, wherein the test object comprises a first defect having predetermined characteristics in the base material and a second defect having predetermined characteristics in the welded region, the method further comprising:
receiving, by the at least one processor, a first plurality of measurements of the first defect;
receiving, by the at least one processor, a second plurality of measurements of the second defect; and
receiving, from the ultrasonic probe, a third plurality of measurements of a flaw-free area of the test object.

13. The method of claim 12, wherein the flaw-free area is in the welded region.

14. The method of claim 12, wherein the first defect is a first hole having a first diameter and the second defect is a second hole having a second diameter, wherein the first and second diameters are sized based on application specific specifications.

15. The method of claim 12, wherein the first plurality of measurements are taken from a first plurality of positions on a first face of the test object, the second plurality of measurements are taken from a second plurality of positions on the first face, and the third plurality of measurements are taken from a third plurality of positions on the first face.

16. The method of claim 15, wherein the ultrasonic probe is a phased array, the method further comprising:
receiving, by the at least one processor, the plurality of measurements at each of the plurality of positions across a predetermined range of angles of incidence;
determining, by the at least one processor, one or more optimal angles of incidence; and
determining, by the at least one processor, the degree of ultrasonic testability of the test object based on the plurality of measurements taken at the one or more optimal angles of incidence.

17. The method of claim 15 wherein the ultrasonic probe is a phased array, the method further comprising:
receiving, by the at least one processor, the plurality of measurements at each of the plurality of positions across a predetermined range of ultrasonic beam frequencies;
determining, by the at least one processor, one or more optimal ultrasonic beam frequencies; and
determining, by the at least one processor, the degree of ultrasonic testability of the test object based on the plurality of measurements taken at the one or more optimal ultrasonic beam frequencies.

18. The method of claim 15, wherein the ultrasonic probe is a phased array, the method further comprising:
receiving, by the at least one processor, the plurality of measurements at each of the plurality of positions across a predetermined range of focal point distances;
determining, by the at least one processor, one or more optimal focal point distances; and
determining, by the at least one processor, the degree of ultrasonic testability of the test object based on the plurality of measurements taken at the one or more optimal focal point distances.
